(19) United States
(12) Patent Application Publication
(10) Pub. No.: US 2012/0031616 A1
(43) Pub. Date: Feb. 9, 2012

(54) Cylindrical Truss Structure Reinforced Pipe

(76) Inventor: David R. Hall, Provo, UT (US)

(21) Appl. No.: 12/849,730

(22) Filed: Aug. 3, 2010

(51) Int. Cl. E21B 36/00; F16L 9/19; F16L 9/14

(52) U.S. Cl. 166/302; 138/148; 138/149; 138/114

(57) ABSTRACT

A pipe structure comprising inner and outer pipe sections that are coaxial with each other is disclosed. A cylindrical truss structure may be disposed between the inner and outer pipe sections to provide support to the pipe structure while reducing weight. Such a pipe structure may be used to form lightweight drill pipe that may be used in oil, gas, geothermal, and horizontal drilling.

### BACKGROUND OF THE INVENTION

The present invention relates to downhole drilling assemblies, specifically downhole drilling assemblies for use in oil, gas, geothermal, and horizontal drilling. Moreover the present invention relates to lightweight drill pipe which may provide a variety of benefits including reduced drilling costs and increased rig capacity. The benefits of lightweight drill pipe, however, must be evaluated in view of a potential decrease in strength of the drill pipe which may occur as weight is decreased and may be detrimental to successful drilling. The following patents disclose attempts to reduce the weight of drill pipe while maintaining a sufficient strength.

U.S. Pat. No. 5,148,876 to Wilson et al., which is herein incorporated by reference for all that it contains discloses an aluminum pipe joint for use in a drill string. Using aluminum drill pipe with stress sleeves in the middle and steel tool joints creates a satisfactory buckling resistant drill string and one that is substantially lighter. Being lighter, there is less friction so the string is able to transmit the required weight on the bit for a greater distance than the steel pipe and thus is able to drill longer horizontal well bores.

U.S. Pat. No. 6,443,244 to Collins et al., which is herein incorporated by reference for all that it contains, discloses a buoyant drill pipe for drilling subterranean wells. The drill pipe, broadly stated, comprises a tubular element, such as a pipe or tube, having one or more buoyant elements attached thereto. The buoyant elements are configured to interact with a drilling fluid in the well bore to provide buoyancy for the drill pipe. The inflatable buoyant element contains a buoyant fluid such as a gas or a liquid, which increases the buoyancy of the drill string in the drilling fluid. The increased buoyancy decreases the weight of the drill string in the wellbore, reduces the torque required to rotate the drill string, and reduces the rotational stresses on the drill string.

### BRIEF SUMMARY OF THE INVENTION

In various embodiments of the present invention a pipe structure may comprise an inner and outer pipe section. The outer pipe section may be coaxial with the inner pipe section and a cylindrical truss structure may be disposed between the inner and outer pipe sections. The cylindrical truss structure may comprise a plurality of straight members comprising ends that are connected at a plurality of nodes to form a plurality of triangular units and at least one node may contact either the inner pipe section or outer pipe section. The plurality of nodes may comprise hinges such that the cylindrical truss structure may expand.

In one embodiment of the present invention the inner pipe section and outer pipe section may unite at a first and second end. The first and second end may also comprise first and second threaded connectors. The first threaded connector may comprise a pin and the second threaded connector may comprise a box end. The first threaded connector may mate with a box end from a second pipe structure and the second threaded connector may mate with a pin end from a third pipe structure. The cylindrical truss structure may be supported through the threaded connections such that the force and load on the pipe structure may be transferred from a first pipe structure to a second pipe structure. The threaded connectors may form a seal with adjacent threaded connectors such that fluid flowing through the inner pipe section does not escape into the outer pipe section.

The pipe structure may comprise electronics disposed between the inner and outer pipe section and interspersed within the cylindrical truss structure. These electronics may comprise resistivity tools, nuclear magnetic resonance tools, seismic/sonic tools, gamma ray tools, downhole logging/measurement tools, processing equipment, power sources, or combinations thereof. Each electronic component may be secured directly to the surface of the inner pipe section or to at least one straight member of the cylindrical truss structure. In another embodiment the pipe structure may comprise insulation between the inner and outer pipe section and throughout the cylindrical truss structure. The insulation may comprise polyurethane, polysterene, or other kinds of spray foam.

In another embodiment of the present invention, the pipe structure may comprise a first and second end. The first and second ends may form seals with adjacent pipe structures such that fluid can flow through the inner pipe section and between the inner and outer pipe sections. The seals may prevent the fluid flowing through the inner pipe section from escaping into the outer pipe section and fluid escaping from the inner pipe section or from between the inner and outer pipe sections. The cylindrical truss structure may comprise carbon, aramid, fiberglass, basalt, bamboo, boron, silicon carbide, flax, steel, epoxy, vinylester, polyester, phenolic, melamine, silicone, polypropylene, PPS, polyamide, PEEK, polyurethane, ceramic or combinations thereof. The cylindrical truss structure may also cause fluid flowing between the inner and outer pipe sections to comprise turbulent flow.

One application of the present pipe structure may exist in the field of geothermal exchange in particular as a method for transferring heat in a downhole well. This method may comprise the steps of providing a pipe structure with an inner and outer pipe section coaxial with each other and a cylindrical truss structure disposed therebetween, disposing the pipe structure within a downhole well in an earthen formation, circulating fluid through the inner pipe section in one direction and between the inner and outer pipe sections in an opposite direction, and transferring heat between the earthen formation and the fluid circulating between the inner and outer pipe sections.

The step of disposing the pipe structure within the downhole well may comprise drilling the pipe structure into the earthen formation. Circulating fluid through the inner pipe section may comprise creating laminar flow and circulating fluid between the inner and outer pipe sections may comprise creating turbulent flow by passing the fluid through the cylindrical truss structure.

Furthermore the method of heat transfer could include an additional step where the cylindrical truss and outer pipe section are expanded in the downhole well putting the outer pipe section in compression with the downhole well borehole removing the need for additional thermally conductive grout.

### BRIEF DESCRIPTION OF THE DRAWINGS

FIG. 1 is a cutaway view of an embodiment of a downhole drill string suspended from a drill rig.

FIG. 2a is a perspective view of an embodiment of a pipe structure comprising inner and outer pipe sections and a cylindrical truss structure disposed there between.

FIG. 2b is a perspective view of an embodiment of a pipe structure comprising an inner pipe section surrounded by a cylindrical truss structure.

FIG. 3 is a longitudinal section diagram of an embodiment of a pipe structure.

FIG. 4 is a perspective view of an embodiment of a pipe structure with a cutaway view showing foam between inner and outer pipe sections.

FIG. 5 is a perspective view of an embodiment of a pipe structure with a cutaway view showing electronics between the inner and outer pipe sections.

FIG. 6 is a longitudinal section diagram of an embodiment of a pipe structure utilized in a thermal exchange application.

FIG. 7 is a cutaway side view of an embodiment of a pipe structure.

FIG. 8a is a cutaway perspective view of an embodiment of a pipe structure.

FIG. 8b is a cutaway perspective view of another embodiment of a pipe structure.

FIG. 9a is a perspective view of an embodiment of a pipe structure comprising an inner pipe section surrounded by a cylindrical truss structure comprising hinges at a plurality of nodes in a collapsed position.

FIG. 9b is a perspective view of another embodiment of a pipe structure comprising an inner pipe section surrounded by a cylindrical truss structure comprising hinges at a plurality of nodes in an expanded position.

### DETAILED DESCRIPTION OF THE INVENTION AND THE PREFERRED EMBODIMENT

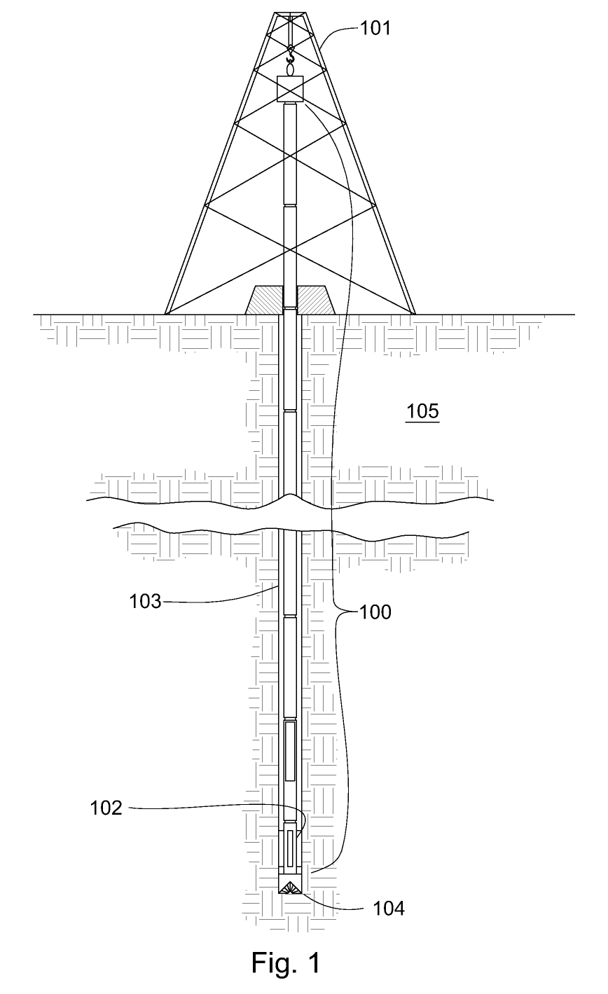

Moving now to the figures, FIG. 1 displays a cutaway view of an embodiment of a downhole drill string 100 suspended from a drill rig 101. A downhole assembly 102 may be located at some point along the drill string 100 and a drill bit 104 may be located at the end of the drill string 100. The drill string 100 may comprise a plurality of pipe structures 103. As the drill bit 104 rotates downhole the drill string 100 may advance farther into soft or hard earthen formations 105. The downhole assembly 102 and/or pipe structures 103 may comprise data acquisition devices which may gather data. Further, surface equipment may send data and/or power to pipe structures 103 and/or the downhole assembly 102.

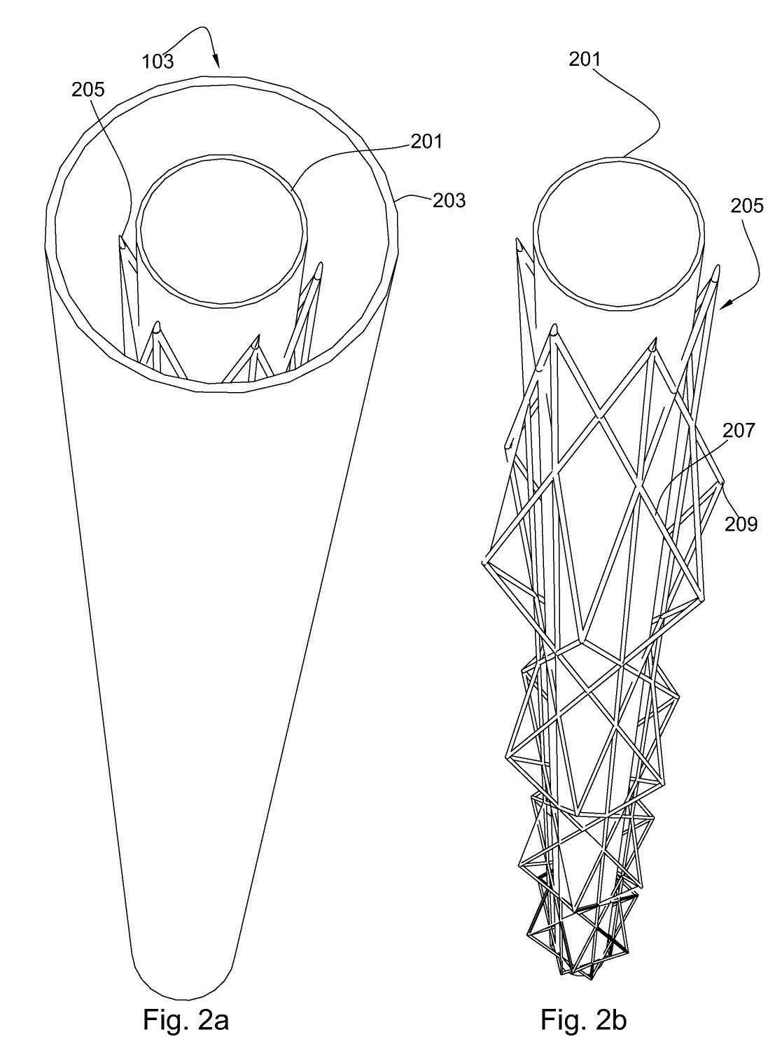

FIGS. 2a and 2b disclose an embodiment of a pipe structure 103. The pipe structure 103 may comprise an inner pipe section 201 and an outer pipe section 203 which may be coaxial with each other. A cylindrical truss structure 205 may be disposed between the inner and outer pipe sections 201, 203. The cylindrical truss structure 205 may comprise a hollow cylinder geometry with an inner and outer diameter. The inner and outer pipe sections 201,203 may be disposed on the inner and outer diameter and comprise different materials for different applications. These materials may include polyethylene, steel, iron, ceramic, Kevlar, or fiberglass.

The cylindrical truss structure 205 may comprise a plurality of triangular units constructed of a plurality of straight members 207 comprising ends that are connected at a plurality of nodes 209. At least one node 209 may be in contact with either the inner pipe section 201 or the outer pipe section 203. The cylindrical truss structure 205 may comprise a three-dimensional truss structure. The three dimensional truss structure may generally consist of six straight members 207 joined at nodes 209 to form a tetrahedron. FIG. 2b discloses the pipe structure 103 with the outer pipe section 203 removed for clarity. The cylindrical truss structure 205 may extend along the entire length of the inner and outer pipe sections 201, 203.

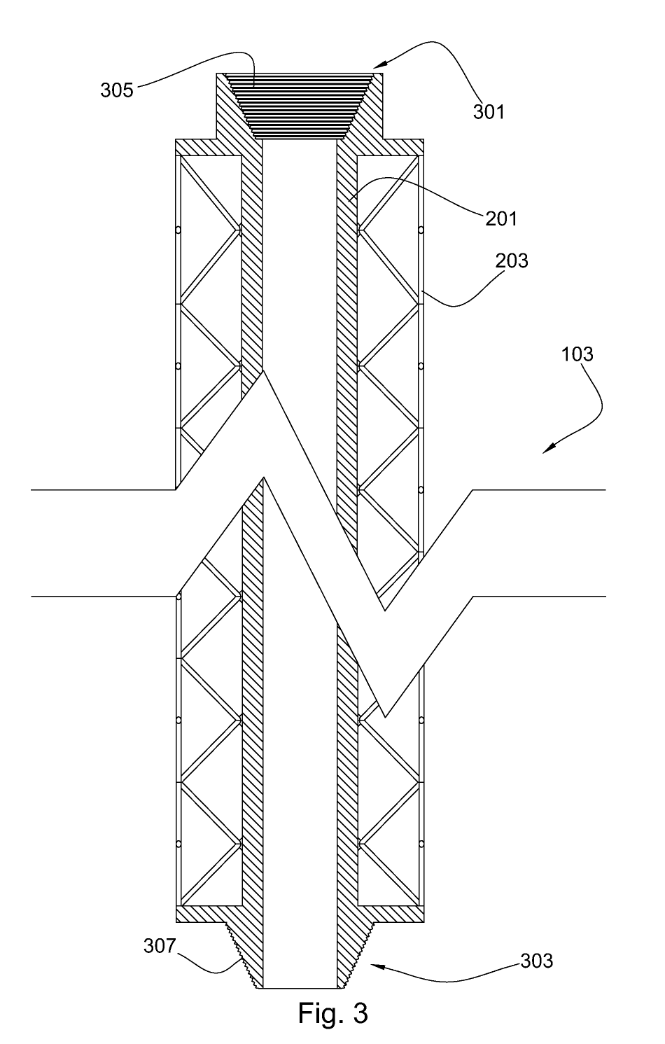

FIG. 3 discloses a longitudinal section diagram of an embodiment of a pipe structure 103. The pipe structure 103 may comprise first and second ends 301, 303. The first end 301 may comprise a box connection 305 and the second end 303 may comprise a pin connection 307. The pipe structure 103 may be joined to a second pipe structure by mating the box connection 305 of the pipe structure 103 with a pin connection of the second pipe structure. The pipe structure 103 may also be joined to a third pipe structure by mating the pin connection 307 of the pipe structure 103 with a box connection of the third pipe structure. The cylindrical truss structure 205 may comprise a connection with the first and second ends 301, 303 such that most of the forces acting on the pipe structure 103 are transferred through the cylindrical truss structure 205.

The box and pin connections 305, 307 may comprise thread forms that when mated create a seal. The seal may inhibit fluid from exiting the inner pipe section 201. The seal may be airtight thus trapping air around the cylindrical truss structure 205. In a downhole environment, the trapped air around the cylindrical truss structure 205 may have a lower density than the drilling fluids in the borehole thus creating buoyancy on the pipe structure 103 further reducing the weight supported by the drill rig. As the weight of the pipe structure 103 decreases, more pipe may be used in drilling thus allowing a drill rig to reach greater depths without increasing the drill rig capacity.

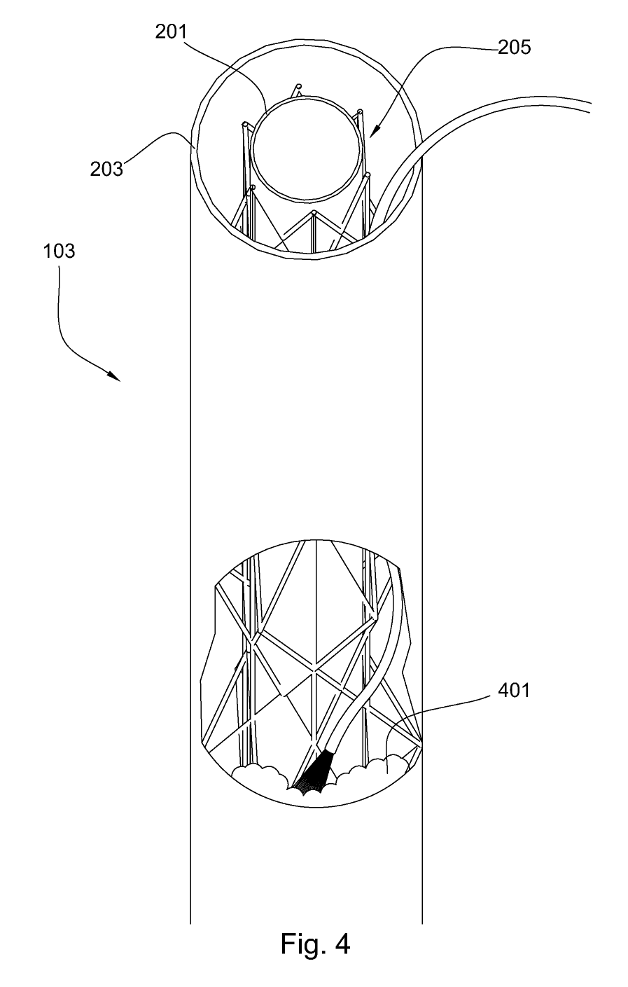

FIG. 4 discloses an embodiment of a pipe structure 103. Sprayable foam 401 may be inserted between the inner and outer pipe sections 201, 203 and in and around the cylindrical truss structure 205. The amount or type of foam 401 inserted may regulate the density of the pipe structure 103 and thus the buoyancy of the pipe structure 103. As the sprayable foam 401 is inserted, it may expand eliminating any gaps between the inner and outer pipe sections 201, 203. The amount of sprayable foam 401 may also directly affect the stiffness of the pipe structure. The sprayable foam 401 may also act as an insulator restricting the transfer of thermal energy between fluid in the inner pipe section 201 and the medium surrounding the pipe structure 103.

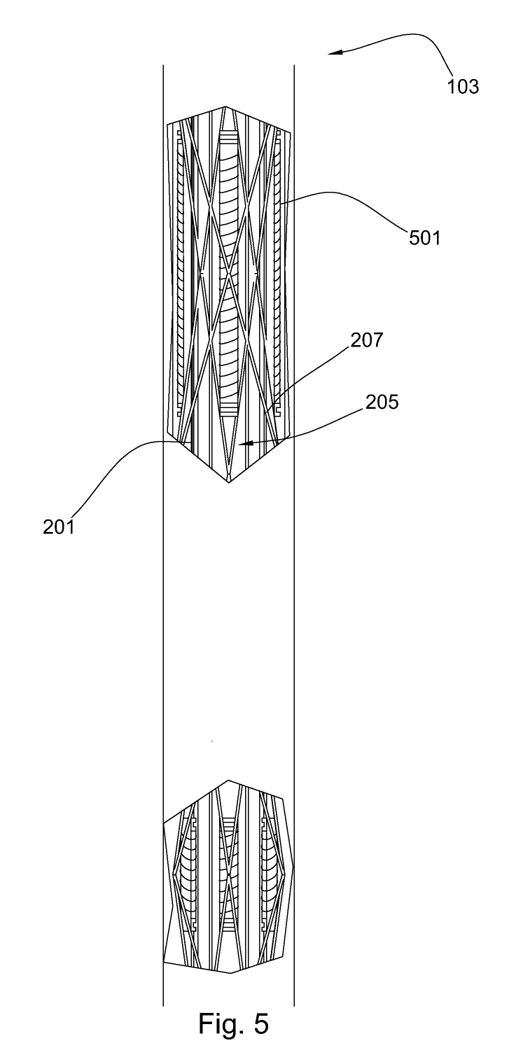

FIG. 5 discloses another embodiment of a pipe structure 103. Transceivers 501 may be disposed between the straight members 207 in the cylindrical truss structure 205. These transceivers 501 may comprise sources and sensors used in resistivity tools, nuclear magnetic resonance tools, seismic/sonic tools, gamma ray tools, or other downhole logging/measurement tools. The transceivers 501 may be secured to a plurality of straight members 207 or to an outer surface of the inner pipe section 201. Other electronics may also be disposed between the inner and outer pipe sections 201, 203. These electronics may include processing equipment, power sources, or combinations thereof.

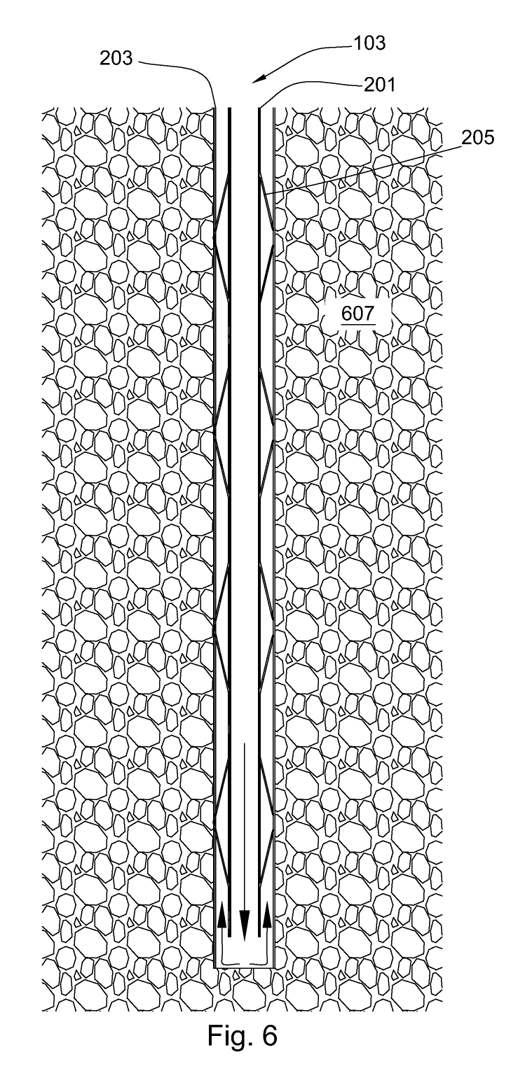

FIG. 6 discloses another embodiment of a pipe structure 103 disposed in an earthen formation 607. A thermal exchange fluid may progress down the pipe structure 103 through the inner pipe section 201 and then progress up the pipe structure 103 between the outer pipe section 203 and the inner pipe section 201. As the thermal exchange fluid progresses up, heat may be exchanged from the earthen formation 607 into the thermal exchange fluid. The cylindrical truss structure 205 may cause turbulent flow in the thermal exchange fluid as it progresses up the pipe structure 103 facilitating a greater heat transfer between the formation 607 and the thermal exchange fluid. A key factor in effective geothermal exchange is the ability to transfer heat from the surrounding formation 607 into the pipe structure 103. Since the outer pipe section 203 of the present invention provides negligible structural support, its thickness can be reduced to provide improved thermal exchange.

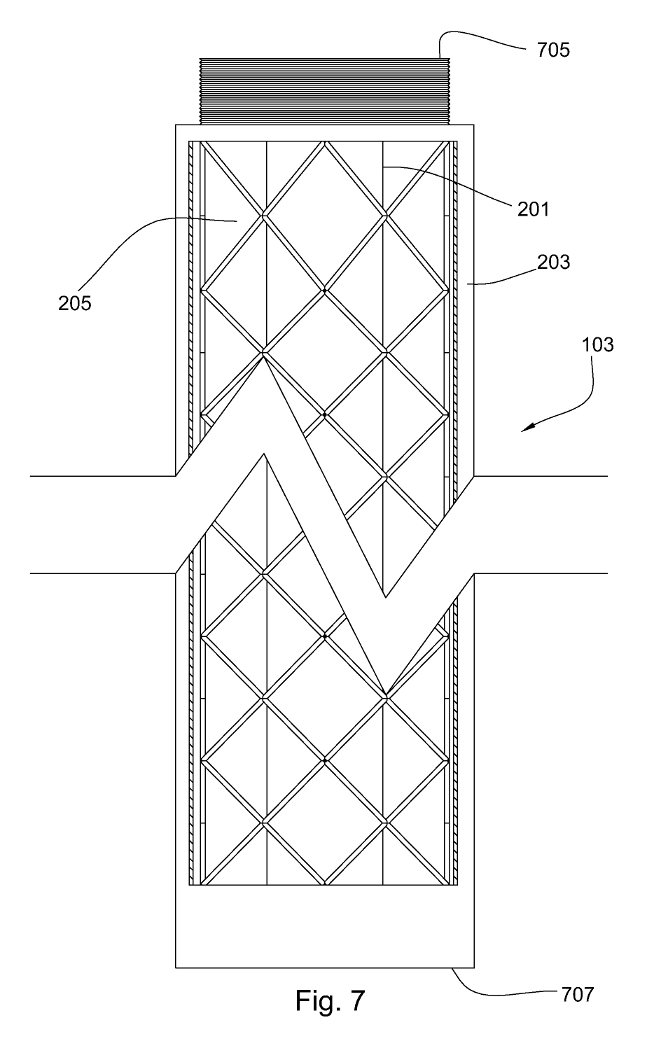

FIG. 7 discloses another embodiment of a pipe structure 103. The pipe structure 103 may comprise first and second ends 705, 707. The first and second ends 705, 707 may form seals with adjacent pipe structures such that fluid may flow through the inner pipe section 201 and between the inner and outer pipe sections 201, 203. The inner pipe section 201 may comprise a material which inhibits thermal transfer between the fluid inside the inner pipe section 201 and the fluid between the inner pipe section 201 and the outer pipe section 203. The cylindrical truss structure 205 may provide support to the pipe structure 103 such that the outer pipe section 203 may comprise a reduced thickness or a malleable material.

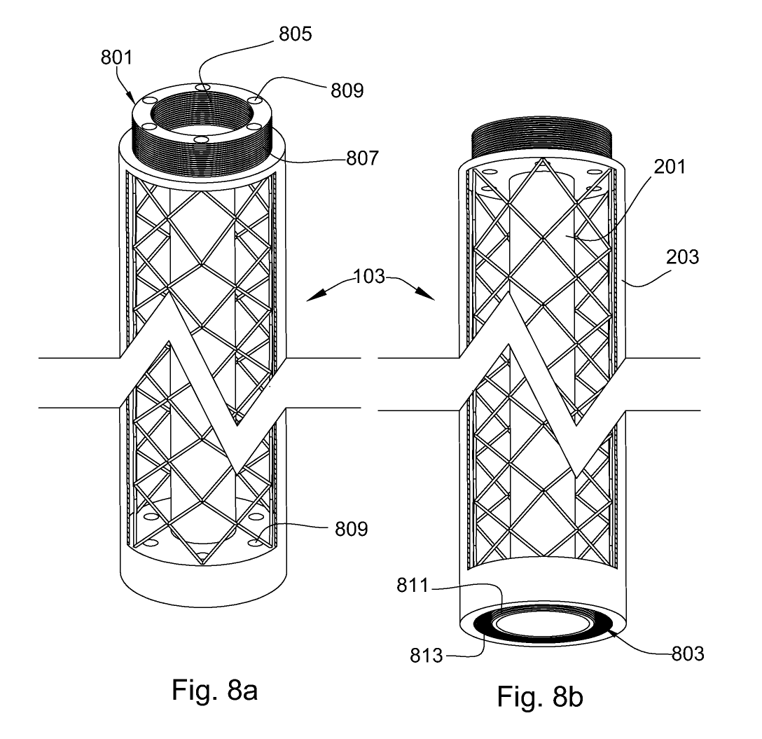

FIGS. 8a and 8b disclose an embodiment of a pipe structure 103. The pipe structure 103 comprises first and second connectors 801, 803. The first connector 801 may comprise first inner and outer thread forms 805, 807 and the second connector 803 may comprise second inner and outer thread forms 811, 813 which may mate with the first inner and outer thread forms 805, 807 respectively. A plurality of channels 809 may be disposed between the first inner and outer thread forms 805, 807 and also between the second inner and outer thread forms 811, 813. The plurality of channels 809 may extend through the thickness of the first and second connectors 801, 803 permitting fluid flow through the first and second connectors 801, 803. The first and second connectors 801, 803 may mate with adjacent pipe structures such that the first and second inner and outer thread forms 805, 807, 811, 813 may create a seal restricting the passage of fluid between the inner pipe section 201 and between the inner and outer pipe sections 201, 203.

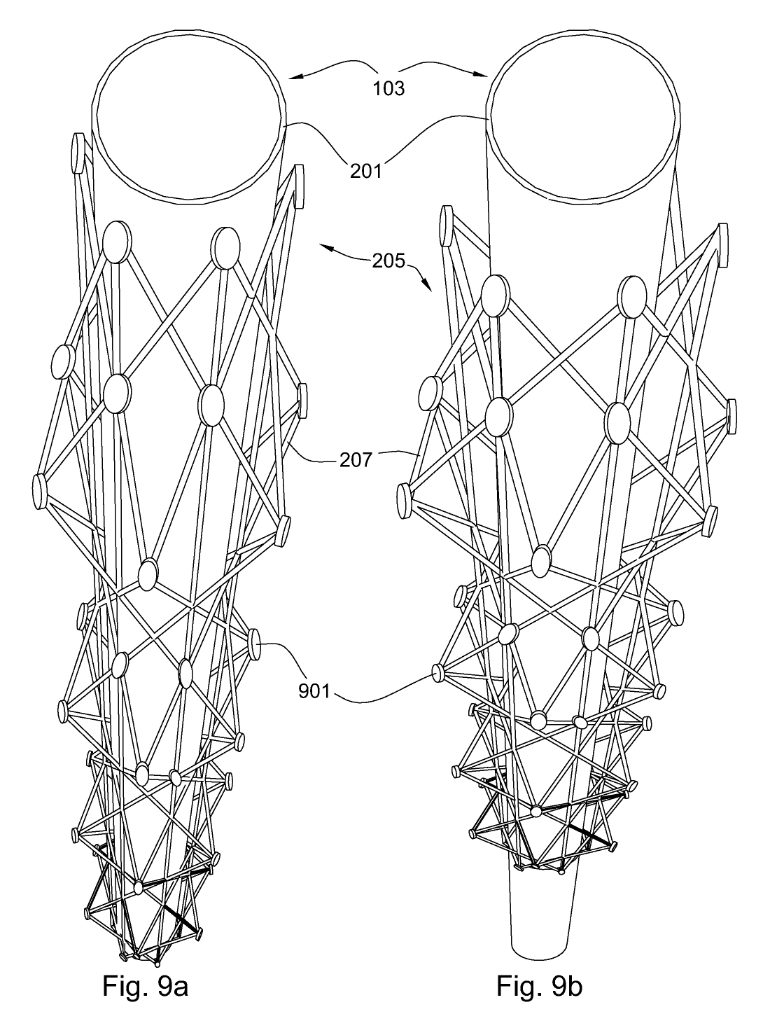

FIGS. 9a and 9b disclose an embodiment of a pipe structure 103. The outer pipe section is removed for clarity. The cylindrical truss structure 205 may comprise straight members 207 connected at nodes. A plurality of nodes may comprise hinges 901 such that the cylindrical truss structure 205 comprises an expanding attribute. FIG. 9a shows the pipe structure 103 in a retracted position while FIG. 9b shows the pipe structure in an expanded position. The inner pipe section 201 may comprise a telescoping pipe which may shrink as the cylindrical truss structure 205 expands or may comprise a rigid pipe.

A geothermal exchange system typically comprises a fluid traveling through a pipe structure disposed within an earthen formation. Thermal energy is then transferred between the fluid and earthen formation as the fluid travels through the pipe structure. The effectiveness of a geothermal exchange system may be directly related to the ability to conduct thermal energy between soil and fluid circulating in a pipe. Pipe thickness as well as grout material can impede thermal conductivity. The cylindrical truss structure 205 may support the pipe structure 103 such that an outer pipe section may comprise a highly thermal conductive material with a reduced thickness. The outer pipe section may also comprise a conformable attribute to facilitate expansion. The expansion of the cylindrical truss structure 205 may also put the outer pipe section in compression with the borehole of a well thus eliminating the need for grout and increasing the overall thermal conductivity of the geothermal exchange system.

Whereas the present invention has been described in particular relation to the drawings attached hereto, it should be understood that other and further modifications apart from those shown or suggested herein, may be made within the scope and spirit of the present invention.

What is claimed is:

1. A pipe structure comprising:
an inner pipe section;
an outer pipe section coaxial with the inner pipe section; and
a cylindrical truss structure disposed between the inner and outer pipe sections.

2. The pipe structure of claim 1, wherein the cylindrical truss structure comprises a plurality of straight members comprising ends that are connected at a plurality of nodes to form a plurality of triangular units.

3. The pipe structure of claim 2, wherein at least one of the plurality of nodes is contacting either the inner pipe section or outer pipe section.

4. The pipe structure of claim 2, wherein at least one of the plurality of nodes comprises a hinge such that the cylindrical truss structure is expandable.

5. The pipe structure of claim 1, wherein the inner pipe section and outer pipe section are united at a first end and a second end and the first and second ends comprise first and second threaded connectors.

6. The pipe structure of claim 5, wherein the first threaded connector comprises a pin which mates with a box end of a second pipe structure and the second threaded connector comprises a box end which mates with a pin of a third pipe structure.

7. The pipe structure of claim 5, wherein the cylindrical truss structure is supported through the first and second threaded connectors.

8. The pipe structure of claim 5, wherein the first and second threaded connectors form a seal with adjacent threaded connectors such that fluid flowing through the inner pipe section does not escape into the outer pipe section.

9. The pipe structure of claim 1, further comprising electronics disposed between the inner and outer pipe sections and interspersed within the cylindrical truss structure.

10. The pipe structure of claim 9, wherein the electronics comprise resistivity tools, nuclear magnetic resonance tools, seismic/sonic tools, gamma ray tools, downhole logging/measurement tools, processing equipment, power sources, or combinations thereof.

11. The pipe structure of claim 1, further comprising insulation between the inner and outer pipe sections and in and around the cylindrical truss structure.

12. The pipe structure of claim 11, wherein the insulation comprises polyurethane, polysterene, or other spray foam.

13. The pipe structure of claim 11, wherein the amount and type of insulation determines the buoyancy of the pipe.

14. The pipe structure of claim 1, further comprising a first end and a second end that form seals with adjacent pipe structures such that fluid can flow through the inner pipe section and between the inner and outer pipe sections.

15. The pipe structure of claim 14, wherein the cylindrical truss structure causes fluid flowing between the inner pipe section and outer pipe section to comprise turbulent flow.

16. The pipe structure of claim 1, wherein the cylindrical truss structure comprises Carbon, Aramid, Fiberglass, Basalt, Bamboo, Boron, Silicon Carbide, Flax, Steel, Epoxy, Vinylester, Polyester, Phenolic, Melamine, Silicone, Polypropylene, PPS, Polyamide, PEEK, Polyurethane, Ceramic or combinations thereof.

17. A method for transferring heat in a downhole well comprising the steps of:
providing a pipe structure comprising an inner and outer pipe section coaxial with each other and a cylindrical truss structure disposed therebetween;
disposing the pipe structure within a downhole well in an earthen formation;
circulating fluid through the inner pipe section in one direction and between the inner and outer pipe sections in an opposite direction; and
transferring heat between the earthen formation and the fluid circulating between the inner and outer pipe sections.

18. The method of claim 17, wherein disposing the pipe structure within the downhole well comprises drilling the pipe structure into the earthen formation.

19. The method of claim 17, wherein circulating fluid through the inner pipe section comprises creating laminar flow and circulating fluid between the inner and outer pipe sections comprises creating turbulent flow by passing the fluid through the cylindrical truss structure.

20. The method of claim 17, further comprising expanding the cylindrical truss structure and outer pipe section such that the outer pipe section is put in compression with the earthen formation.
